(19) United States
(12) Patent Application Publication
(10) Pub. No.: US 2023/0171251 A1
(43) Pub. Date: Jun. 1, 2023

(54) COMMUNICATION METHOD REQUIRING APPROVAL BEFORE COMMUNICATION IS PERMITTED

(71) Applicant: Taunt Digital Limited, London (GB)

(72) Inventor: Michael KALANTIDIS, London (GB)

(21) Appl. No.: 18/072,703

(22) Filed: Dec. 1, 2022

(30) Foreign Application Priority Data
Dec. 1, 2021 (GB) 2117347.1

(51) Int. Cl. H04L 9/40

(52) U.S. Cl. CPC H04L 63/0876

(57) ABSTRACT

A computer-implemented method in a system enabling communication between users, a stored at least one predetermined association existing between each of the users and at least one other of the users, the method comprising: further to input at a user device (12) by a first of the users, receiving (400) a request for communication by the first user with a second of the users (20), the at least one predetermined association not existing between the first and second users; determining (414, 500) that the communication is permitted dependent at least on approval by at least one intermediate users collectively associating the first and second users; requesting (502) approval for the communication from the at least one intermediate user; dependent at least on the approval being received from the at least one intermediate users, permitting (512) the communication.

### CROSS-REFERENCE WITH OTHER APPLICATIONS

The present application claims priority to the UK Patent application no. 2117347.1 filed Dec. 1, 2021; the disclosure of which is incorporated herein by reference in its entirety.

### FIELD OF THE INVENTION

The invention relates to a method of communication in a system where, before communication can be begun by a first user with a second user, approval from at least one further user is required. The system may keep identifying information of the at least one further user and/or the second user anonymous with respect to the first user. The invention also relates to a related communications system.

### BACKGROUND

Many online systems store user profiles for users, enable the users to find other users using the user profiles and enable messages to be sent between the users. Such systems may permit the users to send messages to some users and not others. This may prevent users receiving unsolicited messages containing, for example, personal or professional propositions, and generally receiving high numbers of unwanted messages. Rules may be defined permitting or preventing establishment of communication between users. The rules may depend on relationships between users. For example, where a relationship of a predetermined type exists between two users, messages may be freely sent between the respective users. For example, on Facebook™ users who are “friends” or on Linkedin™ users who are “connections” may be permitted to message each other.

The rules may also be defined to permit or prevent a user sending a message to another user dependent on other factors, for example dependent on user defined permissions in a user's user profile, or on whether the user wishing to send the message is a paying subscriber to the system. A known patent publication, US2020/0228751A1, discloses permitting communication by a third person with a first person dependent on approval by a second person, in order to protect the first person. In systems in which users are permitted to message other users in return for payment, large numbers of unwanted messages are often received by users, which are of little or no relevance to those users and are typically ignored. A problem exists that sometimes a user might reasonably wish to be permitted to contact another user with whom they have no prior direct association without a message being disregarded as spam by the other user.

### SUMMARY OF THE INVENTION

In accordance with a first aspect of the present invention, there is provided a computer-implemented method in a system enabling communication between users and storing at least one predetermined association between each of the users and at least one other of the users, the method comprising: further to input at a user device by a first of the users, receiving a request for communication by the first user with a second of the users, the system not storing the at least one predetermined association between the first and second users; determining that the communication is permitted dependent at least on approval by at least one intermediate user comprising: one intermediate user or a plurality of intermediate users collectively associating the first and second users; requesting approval for the communication from the at least one intermediate user; dependent at least on the approval being received from the at least one intermediate users, permitting the communication.

Thus, the second user can be confident that quality of communication is high and merits attention. The communication may then be provided, for example, the first user may send a message to the second user, or, if the system has already been sent a message by the first user, the system may provide the message to the second user.

The plurality of intermediate users may comprise a chain of intermediate users collectively associating the first and second users.

Where the at least one intermediate user comprises the chain of intermediate users, the first user and a first of the intermediate users may have the at least one predetermined association, the second user and a last of the intermediate users may have the at least one predetermined association, and each intermediate user after the first intermediate user and a respective previous one of the intermediate users in the chain may have the at least one predetermined association.

The at least one predetermined association may comprise an introduced association, the first of the intermediate users having the introduced association with the first user, the second user having the introduced association with the last of the intermediate users, and each intermediate user after the first intermediate having the introduced association with the previous one of the intermediate users in the chain.

The at least one predetermined association may comprise an introducer association, the first user having the introducer association with the first of the intermediate users, the last of the intermediate users having the introduced association with the second user, and each intermediate user other than the last having the introducer association with the next one of the intermediate users in the chain.

The method may further comprise: determining a plurality of candidate users, being a subset of the users, from which the first user can select the second user. The receiving the request may include receiving information indicating a selection of the second user.

The plurality of candidate users may comprise some or all descendant users of the first user. The plurality of candidate users may comprise an introducing user of the first user. The plurality of candidate users comprises some or all ancestor users of the first user, for example including a root user.

The determining that the communication is permitted dependent at least on approval by at least one intermediate users may comprise determining that the second user does not have the at least one predetermined association with the first user.

The user identifiers of the users may be stored in at least one group, the or each group storing all user identifiers in that at least one group having a tree data structure. Each tree data structure may retain information indicative of the at least one predetermined associations between users in that group. A user profile for each user may include the group identifier of the or each group that includes the user identifier of that user. The determining the candidate users may comprise: retrieving the or each group identifier stored in the user profile of the first user; and determining the candidate users based on the or each group. The users whose respective user identifiers are in a particular group are a network of users. Since each user identifier may be in more than one group, each user may be part of a plurality of networks.

The method may further comprise determining the at least one intermediate user. The determining the at least one intermediate user may comprise determining the chain of intermediate between the first user and the second user in the tree data structure.

The method may further comprise: generating, by the system, a mapping between user identifiers of users and anonymized user identifiers; and using the mapping to replace the anonymized user identifiers with the user identifiers when sending data to users, to avoid exposing the identities of users, and using the mapping to replace anonymized user identifiers in received data to user identifiers.

The method may further comprise: providing user data of the candidate users to the first user to enable selection of the second user, wherein the user data of at least some of the candidate users comprises the respective anonymized user identifier and user information relating to the user indicative of at least one of: hobbies, interests, professional activities; comprising only non-personal identifiable information. This means that anonymity of the at least some candidate users is maintained. In an example, the user data of the introduced and/or introducing users may include PII, but the user data of all other candidate users does not. The first user may discover a second user to request communication with based on, for example, common interests, while anonymity is maintained.

The method may further comprise: providing to the user device of the first user information indicative of progress in a process of requesting and receiving approval for the communication from the at least one intermediate user.

The requesting approval for the communication from the chain of intermediate users may comprise requesting approval for the communication sequentially from each of the intermediate users of the chain from the first intermediate user to the last intermediate user.

According to a second aspect of the present invention, there is provided a non-transitory computer program product comprising instructions stored thereon which, when executed by a processor cause performance of the method of the first aspect, including any optional/preferred features or steps thereof.

According to a third aspect of the present invention, there is provided a system for enabling communication between users, and storing at least one predetermined association between each of the users and at least one other of the users, the system being configured to: receive, at a server, from an application at a user device of the first user, a request for communication with a second of the users, the system not storing the at least one predetermined association between the first and second users; determine that the communication is permitted dependent at least on approval by at least one intermediate user comprising: one intermediate user or a plurality of intermediate users collectively associating the first and second users; provide requests for approval for the communication from the at least one intermediate user; dependent at least on the approval being received from the at least one intermediate users, permit the communication.

### BRIEF DESCRIPTION OF FIGURES

Embodiments of the invention will now be described, by way of example only, with reference to the accompanying drawings in which:

FIG. 1 is a diagram showing elements in a communications system in which embodiments of the present invention can be implemented;

FIG. 2A is a diagram indicating information in user profiles of users of the system;

FIG. 2B is a diagram indicating information in group profiles;

FIG. 3 is a diagram of a tree data structure representing associations between the users;

FIG. 4 is a flow diagram indicating steps in determining possible users that a first user can initiate communication and in determining whether approval is required before communication is initiated;

FIG. 5 is a flow diagram indicating steps in an approval process;

FIG. 6 is a flow diagram indicating steps in the approval process in accordance with an alternative embodiment; and

FIG. 7 is a block diagram indicating basic elements of a server on which the communications system may be implemented and run.

### DETAILED DESCRIPTION OF EMBODIMENTS

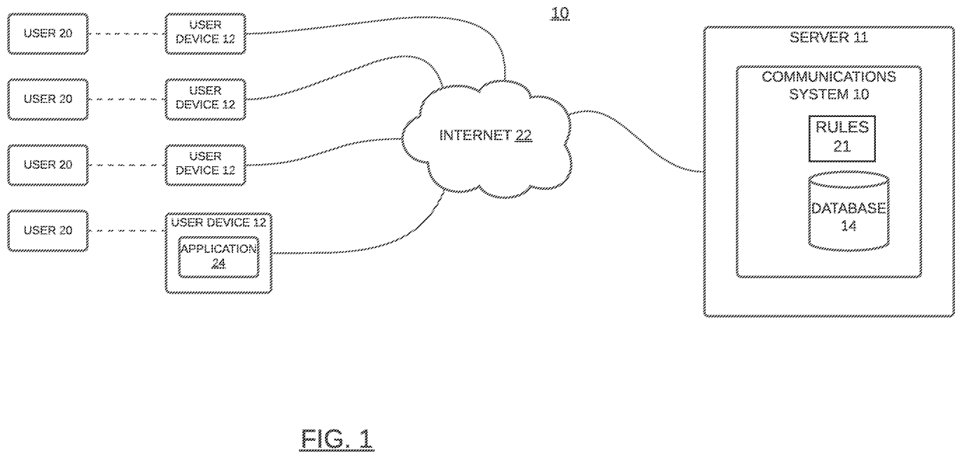

Referring to FIG. 1, according to embodiments of the invention, an online communications system 10 is configured to enable each of a plurality of users 20 to request initiation of communication with other of the users 20 where the initiation of communication is permitted or prevented between particular users dependent on rules 21 of the system 10. A plurality of user devices 12 are each operatively connected to the internet 22 and under the control of a respective one of the users 20. Each user device 20 has a stored application 24 configured to enable communication with the communications system 10 via the internet. The system 10 runs on a server 11. While four users 20 and user devices 12 are indicated in FIG. 1, many are present in practice, as will be appreciated by the skilled person.

Although in the embodiments described below communication is in the form of messages, embodiments are not limited to this or any particular form of communication. For example, the message may be a voice message, video message or a text message, or initiation of communication may comprise setting up a voice call or video call. The initiation of communication may comprise the system acting as an intermediary to initiate communication, for example by forwarding a message provided to the system 10 by a user to a recipient user or by setting up a call via the system. Alternatively, the initiation of communication may comprise enabling initiation of communication between the users directly, without the communication such as a message or call being routed via the system 10.

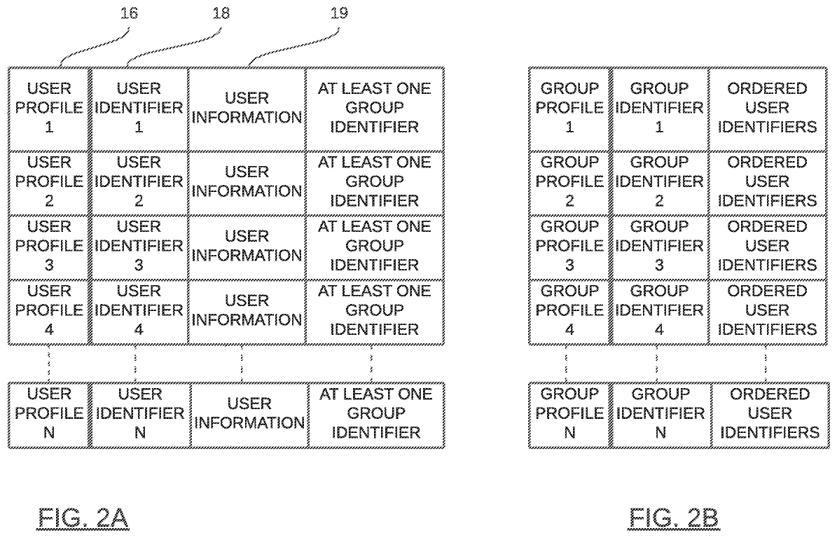

The communications system 10 includes a database 14. Referring also to FIG. 2A, each user has an associated user profile 16 stored in the database 14. Each user profile 16 includes a user identifier 18 and user information 19. The user information 19 may include, for example, a username, a name of the user and personal and/or professional information about the respective user. The personal information may include hobbies and interests. Preferably, the user information 19 does not include personal identifiable information (PII), or includes PII and non-PII each identifiable by the system 10 as such, so that transmission of PII to users can be prevented. The system 10 may be configured so that, where the user information 19 includes PII and non-PII, whether PII is sent outside the system and to which users it may be sent is dependent on the rules 21.

The system 10 is configured to determine a subset of users to whom a user can be permitted to send a message, with or without approval, those users being referred to as “candidate users”. The system 10 is configured to provide user data for the candidate users to the user, so that the user can view the user data and decide based on the user data on one of the candidate users to request sending of a message to. The user data includes, for each of the candidate users, the respective user identifier, or an anonymized user identifier, together with at least a portion of the user information 19. The at least a portion of the user information 19 may include the PII and/or non-PII.

The system 10 is also configured to enable the user to input at the respective user device 12 a selection of one of the candidate users to whom the user wishes to send a message and of a request to send a message to the selected user. The request includes information identifying the selected user. The request includes the message. In variant embodiments, the system 10 may otherwise permit selection or identification of a user to whom a message is to be sent.

According to the rules 21, a message can only be transmitted from a user to at least some of the candidate users if approval for the sending has been received at the system 10 from one or more further of the users. The system 10 is configured so that, for each user, the candidate users for which approval is required are determined at least dependent on associations between the respective user and each of the candidate users. The rules 21 may permit transmission from each user to one or more of the candidate users without need for such approval to be obtained.

The application 24 may be in the form of a web browser or may be a dedicated application that runs on the respective device 12. Requests and replies described herein between the system 10 and application 24 on the user devices 12 are in accordance with a suitable protocol. For example, where the application 24 is a web browser, the system 10 may include a web server, and the protocol may be HTTP or a successor or derivative. Embodiments of the invention are not limited to communication using any particular protocol. The application 24, and the protocol used for transmission of data between the application 24 and the system 10, are such as to implement features and steps described herein.

The system 10 is configured to send approval requests for the further users to review and reply to, and to receive approval replies. The application 24 may be configured to cause a request for approval of sending of a message by the first user to the second user received by a user device 12 of a further user to be presented on a display of that user device 12, and to enable the further user to respond by selection of an approval button or a disapproval button on the display. Additionally or alternatively, the system 10 may be configured to cause a request for approval to be sent by SMS or email, where the respective user may reply with a return SMS or email. Embodiments are not limited to any particular channel by which an approval request is sent to and received by a user, and by which the user sends an approval reply to the system 10. The approval reply need not be by the same channel as the approval request. For example, a request for approval sent by SMS or email may include a predetermined web link, selection of which results in sending of a request containing information indicative of approval or rejection to a preconfigured URL at a web server (not shown) forming part of the system 10.

Each user has at least one predetermined association with at least one other user. In some embodiments, each predetermined association may be one of a plurality of types.

The system 10 is configured to enable users on the system 10 to invite non-users to join as users. A user may invite a non-user by sending an invitation to the non-user as a link. Embodiments are not limited to any particular way in which the link is sent; for example, it may be sent in an SMS, in a message via an internet based messaging service, or by email. Where the application 24 is a web browser, the link may be to a web page where the user may register and create their user profile 16. Where the application 24 is a dedicated application, the link may be for download of the application 24 or to a platform from which the application 24 can be downloaded, after installation of which the user may register via the application 24 and create their user profile 16.

Referring to FIG. 2B, the system 10 stores groups of user identifiers, the user identifiers in each group being ordered in a tree data structure. Each group has an associated group identifier and the users associated with the user identifiers in a group form a network of users. When a new user (“introduced user”) joins the system 10, the system 10 is configured to add the user identifier of the introduced user to the same group as that of the user (“introducing user”) who invited the introduced user. Considering the tree data structure, the introduced user is a child of the introducing user. The introduced user can then invite other users and be an introducing user for the other introduced users where invitations are accepted. The group identifier of the group that each user is associated with is stored in the user profile 16 for that user.

The introducing user who sent the invitation to a user who accepted the invitation and consequently joined the system 10 has an association of a first type (an “introducer association”) with the introduced user. The introduced user has an association of a second type (an “introduced association”) with the introducing user.

The system 10 may also enable a user to join the system 10 without an invitation and thus to set up a user profile 16. The system 10 may in some embodiments be configured to allow this only after a verification process. A user who joins without an invitation does not have an introduced association with any other user.

Also, a user can send an invitation to another user to join a group that the user is in. In this case, the user identifier of the invited user, provided the invitation is accepted, is added to the respective group as an introduced user of the inviting user, the inviting user being the introducing user. Thus, the user identifier of each user 20 of the system 10 may be a member of a plurality of groups and a plurality of group identifiers may be stored in the user profiles 16 of the users 20.

The system 10 may also enable users to begin their own new groups. Considering the tree data structure, such a user is a “root user” in a new group. Users 20 who join the system 10 without an invitation may begin their own groups.

By virtue of the tree data structure, each group retains information indicative of the associations between users due to the ordering of the users. The tree data structure includes all user identifiers of all users in a particular group.

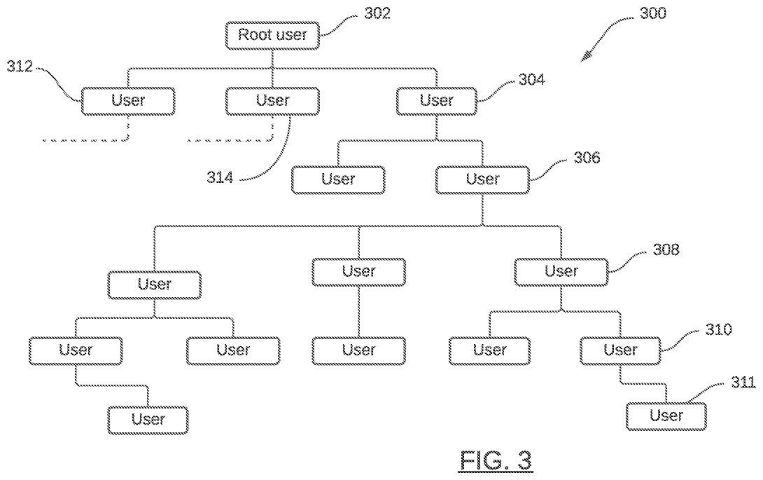

Referring also to FIG. 3, in an example tree data structure of a group, a user who joined the system 10 without an invitation or who began their own group is represented as a root node and referred to as the “root user”. Each user 304, 312, 314 (“first child user”) with whom a root user has an introducer association is represented as a first child node of the root node 302. Each user 306 (“second child user”) with whom a first child user has an introducer association is represented as a child node (“second child node”) of the respective first child node. Generally, each user (“(n+1)th child users”) with whom a nth child user has an introducer association is represented as the (n+1)th child node. All of the child users deriving from one root user are descendants of that root user. All of the child users represented as being further away from the root user than a particular user are descendants of that user. All users closer to the root user than a particular user, together with the root user, are ancestors of that user.

The system 10 is configured to determine for each user the candidate users for messaging. The candidate users comprise all of the descendant users and ancestor users, including the root user, of that user in the or each group identified in the user profile of the user. The system 10 may be configured to provide user data of the candidate users to the application 24 to aid the user 20 in selecting one of the candidate users to initiate messaging with. The user data may comprise a user identifier or an anonymized user identifier of the respective candidate user. The user data may comprise at least some of the user information 19 of the respective candidate user. The at least some information 19 may be non-PII and/or PII. Additional functionality for filtering candidate users may be provided. For example, a user may be able to filter at the respective user device 12 by group, based on the at least some information 19, or based on a maximum number of approval requests and replies would be required in order for communication to be permitted.

The rules of the system 10 permit each user to message the user's introducing user (that is, parent), if one is present, and the user's introduced users (that is, children), if any, directly without need for approval from any further user. The system 10 is configured to enable each user to select for messaging and to request sending of a message to each other of the descendent users, provided approval is first obtained from each descendent user between the respective user and the intended recipient user of the message, and each other of its ancestor users, provided approval is first obtained from each ancestor user between the respective user and the intended recipient. The one or more users between the user wanting to send a message and the intended recipient are referred to herein as “intermediate users” or above as “further users”. In variant embodiments, the rules may be different, for example the candidate users may not include a user's introducing user, or other criteria may be specified restricting which of the ancestor and descendant users are candidate users. For example, there may not be more than a predetermined number of intermediate users between the user and any of the candidate users. The other criteria may include permissions settable by each user effecting who may contact them.

Although not essential to all embodiments, the system 10 is preferably configured not to send any PII of the intermediate users to the user device 12 of the user wanting to send a message, thereby to prevent the user from seeing or otherwise having access to PII of the intermediate users. In some embodiments, the system 10 may be configured not to send any PII of the intermediate users to the recipient user.

In some embodiments, the system 10 is configured not to send any PII of the candidate users to the user device 12 of the user wanting to select a user to send a message to.

To avoid sending of user identifiers outside the system 10, the system 10 is configured to map the user identifier to an anonymized user identifier and to store the user identifier in association with the anonymized identifier. The anonymized user identifier can then be used in place of the user identifier and mapping can occur between the two identifiers at an API of the system 10. In embodiments in which anonymity of the candidate users is maintained, the system 10 is configured to send only non-PII with the anonymized user identifier.

In a preferred embodiment, the anonymized user identifiers are stored alongside user identifiers temporarily, for example in RAM. Each anonymized user identifier is generated using the user identifier and additionally an anonymization function that depends on the respective group identifier and/or the tree structure of the group and/or an alternative number or character string specific to the relevant group. Thus, the anonymized user identifier is specific to the user and to the group. Embodiments are not limited to any particular way in which the anonymized user identifiers are generated. In some embodiments, the mappings may be stored permanently. The anonymized user identifiers may change since they are dependent on the user identifiers in the group, and this may change.

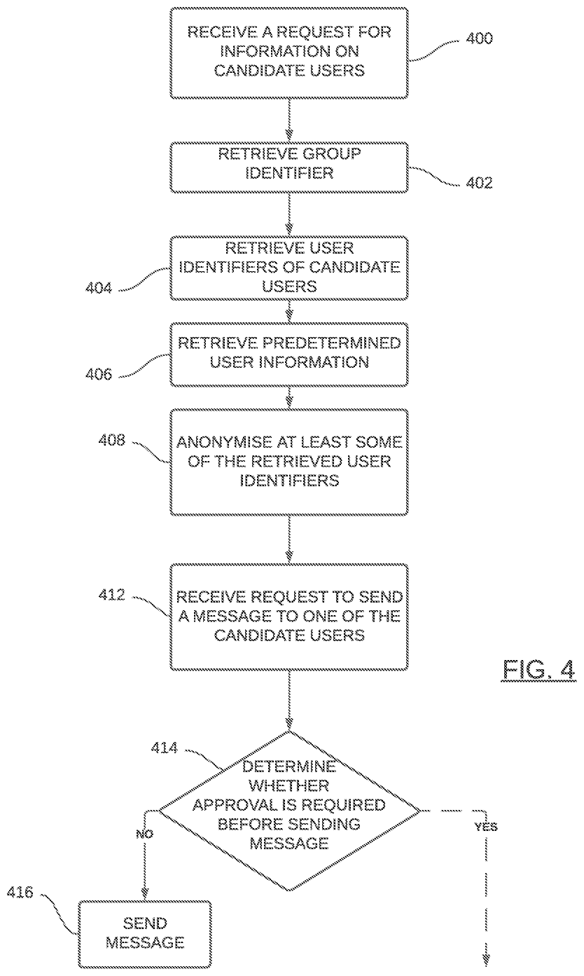

Operation of the system 10 is now described with reference to FIG. 4 and first and second of the users 20. First, the first user operates the respective user device 12 and input is thus received at strep 400 requesting to see the user data of respective candidate users, and a request is sent by the user device 12 for this information to the system 10. In response to this, at step 402, the system 10 retrieves the group identifier stored in the user profile 16 of the first user. The system 10 then determines the candidate users from users in the group by retrieving user identifiers of the descendant and ancestor users of the first user from the stored group identified by the group identifier at step 404. Thus, the system 10 has retrieved the user identifiers of all the candidate users. The system 10 then retrieves the user information 19 for each of the candidate users also at step 406.

At step 408, the system 10 anonymizes the user identifiers of the candidate users by generating anonymized user identifiers and storing a mapping of each user identifiers to the associated anonymized identifier. Thus, provided the user information 19 includes only non-PII, the application 24 is not sent any information from which the identity of the candidate users can be derived. This step 408 may be omitted in variant embodiments. Alternatively, in this step 408 some of the user data of some but not all candidate users is kept anonymous. For example, the user data of the user's introducing user, if any, and introduced users, may not be anonymized, but the user data of all other candidate users are.

The user device 12 then receives input from the user 20 of selection of one of the candidate users and at step 412 a request to initiate sending of a message to the selected user (now referred to as the “second user”) is received at the system 10. The request includes a message. In variant embodiments, the user device receives input of such a request but without a message. In this case, the inputting of the message is performed after the system 10 confirms that sending is permitted, such as after approval from any intermediate users is received.

At step 414, the system 10 determines if the message can be sent to the second user dependent on the rules 21. Thus, the system 10 determines whether the rules 21 preventing the sending are met. In embodiments, the rules 21 do not prevent sending where the second user is an introducing user or introduced user of the first user. If the second user is one of these, the message is sent at step 416. In variant embodiments, whether the sending is permitted or prevented may also be dependent on other criteria, as already mentioned. If the system 10 determines that the message cannot be sent without approval by intermediate users, a process of obtaining approval is begun.

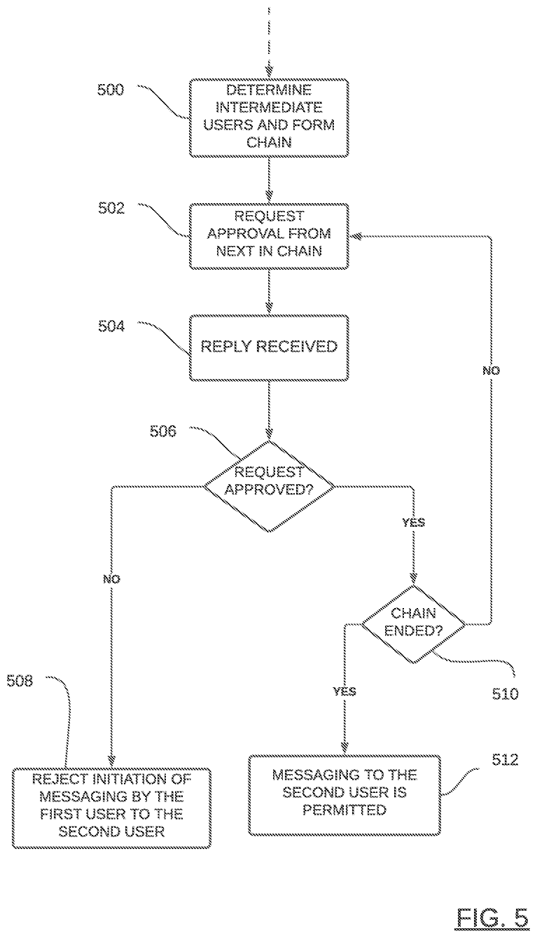

Referring to FIG. 5, at step 500, the system 10 determines the intermediate users between the first user and the second user using the tree data structure of the relevant group. The determined intermediate users form an ordered list or chain of users between the first user and the second user. If candidate users have been determined from more than one group, the system 10 may determine the intermediate users in each group and select to use the intermediate users forming the shortest chain, that is, with fewest intermediate users. In variant embodiments, the system 10 may select to use the intermediate users from one of the groups dependent on one or more other criteria; for example, in some embodiments the reply time by which intermediate users have responded in the past to approval requests may be recorded and the system 10 may select to use intermediate users from one of the groups dependent on the reply times, or the likelihood that intermediate users reply to approval requests at all may be recorded and the system 10 may select to use intermediate users from one of the groups dependent on the likelihoods.

At step 502, the system 10 sends an approval request to the intermediate user adjacent the first user in the chain and awaits a reply. At step 504, the system 10 receives a reply indicating approval or disapproval. Optionally, at step 502 a timer is also begun and, where there is no reply, after a predetermined time period the timer expires and this is taken as disapproval. If the system 10 determines that the request is approved at step 506, then at step 510 the system 10 determines if each intermediate user in the chain has approved the request. If not, step 502 is repeated with the next intermediate user in the chain being sent an approval request and a response may be received at repeated step 504. After approval requests have been sent to each intermediate user in the chain and replies received indicating approval, sequentially, the system 10 permits messaging of the second user by the first user at step 512. If any one of the intermediate users rejects the approval request, the system 10 does not send approval requests to any further of the intermediate users, does not enable the messaging and notifies the first user accordingly at step 508. In some embodiments, the system 10 notifies the first user each time an approval request is approved. Additionally or alternatively, the system 10 notifies the first user if an approval request is refused.

In alternative embodiments, the system 10 may otherwise determine the candidate users at step 404. In some such embodiments, the system 10 may determine the candidate users from users in the identified group by retrieving user identifiers of the descendant users or the ancestor users of the first user. In some such embodiments, the system 10 may determine the candidate users from users in the identified group by retrieving user identifiers of descendant users omitting introduced users (i.e., the first user's children), or by retrieving user identifiers of ancestor users omitting the introducing user (i.e., the first user's parent). Further, in some embodiments, the first user may be in a plurality of groups. In this case, the system 10 may retrieve more than one group identifier from the user profile 16 and may determine the candidate users as comprising ancestor and/or descendent users from each of the groups, optionally excluding, respectively, the introducing user or introduced users. Embodiments of the invention are not limited to how the candidate users are determined from the users in the identified group or groups.

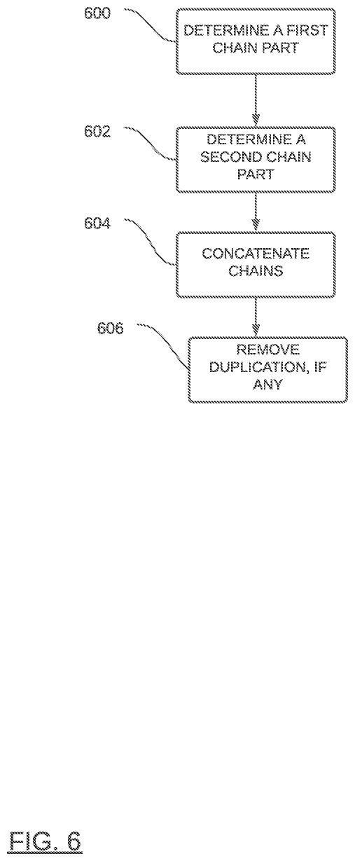

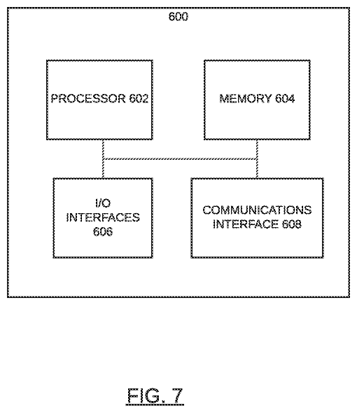

The above-described embodiments can be used where a second user to be messaged is a descendant or ancestor of the first user. Embodiments are not limited to where the candidate users are such. The candidate users may be otherwise determined. In other embodiments, the candidate users instead comprise all other users in a group, optionally excluding, respectively, the introduced user or introducing users. In this case, the same processes may be used, save in that they are modified as follows. Step 404 is modified to identify the candidate users accordingly. Step 500 is modified into steps 600-606. Referring to FIG. 6, at step 600 the system 10 determines a first chain part comprising all users between the first user and the root user using tree data structure of the group. At step 602, the system 10 determines a second chain part comprising all users between the second user and the root user. At step 604, the system 10 then concatenates the second chain part to the end of the first chain part. If any duplicate user identifiers appear, the system 10 removes one of the duplicates at step 606. This results in a chain of intermediate users between the first and second users. The approval process of FIG. 5 is then used to obtain approval for the first user to initiate communication.

In alternative embodiments, the groups of user identifiers ordered in a tree data structure are not stored. Alternative ways of determining candidate users are used. In such alternative embodiments, each user profile 16 stores, instead of a group identifier, a user identifier of each introduced user. The system 10 determines the candidate users with respect to the first user by retrieving the user identifier of each user introduced by the first user, and then, by reference to the user profile of each introduced user, each introduced user of those introduced users, continuing iteratively until all descendent users have been identified. Additionally or alternatively, each user profile 16 stores a user identifier of each introducing user. The system 10 determines the candidate users by retrieving the user identifier of the introducing user of the first user, and then, retrieving the user identifier of the introducing user of that introducing user, continuing iteratively until all ancestor users have been identified.

In such alternative embodiments, the system 10 may determine the intermediate users in a modified step 500 by retrieving the introducing user (parent) of the second user, then looking up the user identifier of the next parent along towards the first user, and so on iteratively looking up each next parent until the first user is reached. The remaining steps described with reference to FIG. 5 are then carried out.

In alternative embodiments, each user profile 16 also includes a list of user identifiers of other users who have a predetermined association of another type with the respective user. These are referred to herein as “contacts”. In prior art systems such other users may be known as “friends”, for example on Facebook™, or “connections”, for example on Linkedin™. A list of user identifiers of contacts is stored in the user profile. Contacts may be obtained by a process of invitation by one user to another user, and acceptance by the user other.

The candidate users for a user comprise contacts, contacts of contacts and further users associated with the user by a chain of contact. Contacts may be messaged without need for approval by any further user. Instead of steps 400-406, the system 10 determines the candidate users by retrieving the contacts of the first user, retrieving the contacts of each contact of the first user, and so on iteratively. The system 10 may limit the number of iterations, for example so that only non-contacts that are n users from the first user are identified. In this embodiment, the candidate users can be stored for the first user, permanently or temporarily in a tree data structure in which the first user is the root user with all the candidate users are descendant users.

In such alternative embodiments, step 414 is modified to determine that approval is required where a selected second user is a non-contact of the first user. If the selected second user is a contact of the first user, transmission of a message is permitted and so the message is sent at 416. If the selected second user is a non-contact, the at least one intermediate users are determined between the first and second users at step 500 and the remaining steps described with reference to FIG. 5 are then carried out.

In some embodiments, the system 10 may send to the user device 12 of the second user and/or the second user no PII of the intermediate users, to prevent the second user learning who has approved or rejected the message transmission. In some embodiments, the number of intermediate users may be provided by the system 10 to the respective user device 12 of the first user and/or the second user, but the identities of some or all intermediate users may be anonymized. For example, the introducing user of the second user may be identified but all others may be anonymized. This number correspond to the number of approvals that must be obtained.

In some embodiments, the system 10 is configured to provide information to the user devices 12 enabling display to the first user and/or the second user of a visual representation of the chain of intermediate users between the first user and the second user. The visual representation may include a visual indication, for each intermediate user in the chain, of whether that intermediate user has been sent and/or replied to an approval request. The user can understand the number of intermediate users between the user and each descendant user. Thus, the user can understand number of approvals that have to be obtained before communication will be initiated.

The methods described above of enabling communication dependent on the one or more rules being met may be usefully implemented in online social or professional networking systems. A second user with whom communication is initiated by a first user is much more likely to be receptive to replying where initiation of communication has been approved by intermediate users. Also, the methods prevent spamming.

In the embodiments described above, the steps described with reference to FIGS. 4 and 5 are implemented at the system 10 at the server 11. In variant embodiments, some of the steps may occur at the application 24. For example, provided the steps described with reference to FIG. 5, and variants and modifications thereof, could be carried out at the application 24.

FIG. 6 depicts a high-level block diagram of a general-purpose computer suitable for use in performing functions of the server 11 described herein. The server 600 comprises a processor 602, a memory 604, various input/output devices 606 and a communications interface 608.

Instructions executable to perform steps of embodiments of the invention may be stored in the memory 604. The system 10 may be loaded into memory 604 and executed by processor 602 to implement the functions as discussed above. As such, the system 10 can be stored on a computer readable storage medium.

The processor 602 may be any type of processor suitable for execution of such instructions, including but not limited to a general-purpose digital signal processor or a special purpose processor. In some embodiments, electronic circuitry including, for example, programmable logic circuitry, field-programmable gate arrays (FPGA), or programmable logic arrays (PLA) may execute the instructions by utilising state information of the instructions to personalise the electronic circuitry, in order to perform aspects of the present invention.

The memory 604 may be implemented using any suitable memory technology. The memory 604 may include RAM or other dynamic, volatile storage (e.g. SDRAM, DDR SDRAM, RDRAM, SRAM, etc.), and/or ROM or other non-volatile memory (e.g. FROM, EPROM, EEPROM, Flash memory), for storing data and instructions for execution by the one or more processors 602. Typically, the server 600 includes an operating system (OS) stored in the non-volatile memory. The term “memory” is used herein to refer to any physical component that can retain or store instructions and data on a temporary or permanent basis. Instructions and data are stored in the memory 604 and are accessible by the processor 602 and enable the server 600 to implement embodiments of the present invention as described herein.

The communications interface 608 allows software and data to be transferred between the server 11 and external devices, via a local network or via the internet or other network. The communications interface may support communication via any suitable wired or wireless general data networks, such as types of Ethernet network, telecommunications/telephony networks, for example, or via any other suitable type of network and/or protocol.

Multiple servers such as that illustrated in FIG. 6 may be used to implement the described functionality; for example, software components running on a variety of different computing devices may collaborate to provide the functionality.

The user device 12 may be a personal computer, a tablet, a smartphone, or any device capable of running the application 24. The user device also includes application code in a non-volatile memory, which is executable in a volatile memory during runtime.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A computer-implemented method in a system enabling communication between users and storing at least one predetermined association between each of the users and at least one other of the users, the at least one predetermined association comprising an introduced association, the method comprising:
further to input at a user device by a first of the users, receiving a request for communication by the first user with a second of the users, the system not storing the at least one predetermined association between the first and second users;
determining that the communication is permitted dependent at least on approval by at least one intermediate user, the at least one intermediate user comprising:
one intermediate user, wherein the second user has the introduced association with the one intermediate user, and the one intermediate user has the introduced association with the first user, or
a chain of intermediate users collectively associating the first and second users, wherein a first of the intermediate users has the introduced association with the first user, the second user has the introduced association with a last of the intermediate users, and the or each intermediate user after the first intermediate user has the introduced association with a respective previous one of the intermediate users;
requesting approval for the communication from the at least one intermediate user;
dependent at least on the approval being received from the at least one intermediate users, permitting the communication.

2. The method of claim 1, further comprising:
determining a plurality of candidate users, being a subset of the users, from which the first user can select the second user;
the receiving the request including receiving information indicating a selection of the second user.

3. The method of claim 2, wherein the plurality of candidate users comprises some or all descendant users of the first user.

4. The method of claim 2, wherein the plurality of candidate users comprises an introducing user of the first user.

5. The method of claim 2, wherein the plurality of candidate users comprises some or all ancestor users of the first user.

6. The method of claim 1, wherein the determining that the communication is permitted dependent at least on approval by at least one intermediate users comprising determining that the system does not store the at least one predetermined association between the first and second users.

7. The method of claim 2, wherein user identifiers of the users are stored in at least one group having a tree data structure, the tree data structure retaining information indicative of the introduced associations between users, wherein a user profile for each user includes the group identifier of the at least one group that includes the user identifier of that user, wherein the determining the candidate users comprises:
retrieving the at least one group identifier stored in the user profile of the first user;
determining the candidate users based on the user identifiers in the at least one group.

8. The method of claim 1, further comprising determining the at least one intermediate user.

9. The method of claim 7, further comprising determining the at least one intermediate user, wherein the determining the at least one intermediate user comprises determining the chain of intermediate users as corresponding to user identifiers between the first user and the second user in the tree data structure.

10. The method of claim 1, further comprising:
generating, by the system, a mapping between user identifiers of users and anonymized user identifiers;
using the mapping to replace the anonymized user identifiers with the user identifiers when sending data to users, to avoid exposing the identities of users, and using the mapping to replace anonymized user identifiers in received data to user identifiers.

11. The method of claim 10, further comprising:
determining a plurality of candidate users, being a subset of the users, from which the first user can select the second user;
the receiving the request including receiving information indicating a selection of the second user.
providing user data of the candidate users to the first user to enable selection of the second user, wherein the user data of at least some of the candidate users comprises the respective anonymized user identifier and user information relating to the user indicative of at least one of: hobbies, interests, professional activities; comprising only non-personal identifiable information.

12. The method of claim 1, further comprising:
providing to the user device of the first user information indicative of progress in a process of requesting and receiving approval for the communication from the at least one intermediate user.

13. The method of claim 1, wherein the requesting approval for the communication from the chain of intermediate users comprises requesting approval for the communication sequentially from each of the intermediate users of the chain from the first intermediate user to the last intermediate user.

14. The method of claim 1, wherein the at least one intermediate user comprises the chain of intermediate users.

15. A method at a user device of a first user, comprising:
receiving user data of candidate users;
causing display on the user device of the user data of at least some of the candidate users;
receiving input from a user of a selection of a second user from the candidate users;
sending the selection to a remote system;
receiving information indicative of progress in a process of obtaining approval for communication with the second user from at least one intermediate user collectively associating the first and second users, the at least one intermediate user comprising:
one intermediate user, wherein the second user has an introduced association with the one intermediate user, and the one intermediate user has the introduced association with the first user, or
a chain of intermediate users collectively associating the first and second users, wherein a first of the intermediate users has the introduced association with the first user, the second user has the introduced association with a last of the intermediate users, and the or each intermediate user after the first intermediate user has the introduced association with a respective previous one of the intermediate users, wherein, in said obtaining approval for communication with the second user approval is requested for the communication sequentially from each of the intermediate users of the chain, wherein approval from a next of the intermediate users is requested after approval from the previous one of the intermediate users is received;
causing display on the user device of the information.

16. The method of claim 15, wherein the user data of at least some of the candidate users does not include any personal identifiable information.

17. The method of claim 15, wherein the information does not include any personal identifiable information of at least some of the at least one intermediate users.

18. A system for enabling communication between users, and storing at least one predetermined association between each of the users and at least one other of the users, the at least one predetermined association comprising an introduced association, the system being configured to:
receive, at a server, from an application at a user device of the first user, a request for communication with a second of the users, the system not storing the at least one predetermined association between the first and second users;
determine that the communication is permitted dependent at least on approval by at least one intermediate user, the at least one intermediate user comprising:
one intermediate user, wherein the second user has the introduced association with the one intermediate user, and the one intermediate user has the introduced association with the first user, or
a chain of intermediate users collectively associating the first and second users, wherein a first of the intermediate users has the introduced association with the first user, the second user has the introduced association with a last of the intermediate users, and the or each intermediate user after the first intermediate user has the introduced association with a respective previous one of the intermediate users;
provide requests for approval for the communication from the at least one intermediate user;
dependent at least on the approval being received from the at least one intermediate users, permit the communication.

19. The system of claim 18, wherein the at least one intermediate user comprises the chain of intermediate users.

20. The system of claim 19, further comprising determining the at least one intermediate user, wherein the determining the at least one intermediate user comprises determining the chain of intermediate users as corresponding to user identifiers between the first user and the second user in the tree data structure.
